(19) United States
(12) Patent Application Publication
(10) Pub. No.: US 2012/0188798 A1
(43) Pub. Date: Jul. 26, 2012

(54) SWITCHING POWER SOURCE AND IMAGE FORMING APPARATUS HAVING SWITCHING POWER SOURCE

(75) Inventor: Shinichiro Matsumoto, Kawasaki-shi (JP)

(73) Assignee: CANON KABUSHIKI KAISHA, Tokyo (JP)

(21) Appl. No.: 13/353,076

(22) Filed: Jan. 18, 2012

(30) Foreign Application Priority Data
Jan. 21, 2011 (JP) 2011-011153

(51) Int. Cl. H02M 3/335

(52) U.S. Cl. 363/21.12

(57) ABSTRACT

In a converter, when an output voltage is set to a low voltage, a switching element is turned on according to a pulse voltage induced in an auxiliary winding having the same winding direction as that of a primary winding of a transformer.

### BACKGROUND OF THE INVENTION

1. Field of the Invention

Embodiments of the present invention relate to a switching power source of pseudo-resonance type.

2. Description of the Related Art

FIG. 10 illustrates a circuit configuration of a conventional switching power source apparatus of pseudo-resonance type (hereinafter, referred to as a pseudo-resonance converter). FIG. 11 illustrates operational waveforms of the circuit in FIG. 10. In FIG. 10, Vac is an alternating current (AC) voltage from a commercial AC power source. When a switch SW1 is turned on, the AC voltage Vac is rectified by a rectifier diode bridge DA1 including diodes D101, D102, D103, and D104, and is smoothed by a primary electrolytic capacitor C1 to become a nearly constant voltage Vh.

Meanwhile, at the same time, a control module CNT1 (hereinafter, referred to as a control unit CNT1) is supplied with voltage via an activation resistor R4. The control unit CNT1 turns on a field effect transistor (FET) 1 serving as a switching element. When the FET 1 is turned on, a drain current Id flows through the FET 1 via a primary winding Np of a transformer T1 (t0).

The Id is converted into voltage Vis by a current detecting resistor R3, and is supplied to the control unit CNT1. The control unit CNT1 turns off the FET 1, at a time point when the voltage Vis has reached a predetermined value (t1). When the FET 1 is turned off, the Id becomes instantaneously zero. A current Ip of the primary winding Np, which has been flowing through the FET 1 until that time, flows into and charges a primary resonance capacitor C2. Then, a drain-source voltage Vds of the FET 1 begins to increase.

Then, immediately after the FET 1 is turned off, a value of the drain-source voltage Vds jumps greatly (t2). The surging voltage waveform is an inductance-capacitance (LC) resonance phenomenon between a leakage inductance Lpr of the primary winding Np and a capacitance Cr1 of the primary resonance capacitor C2.

Thereafter, the Vds becomes a nearly constant voltage Vh+Vcl (duration from t2 to t3). A secondary winding Ns and an auxiliary winding Nn, in addition to the primary winding Np, are wound over the transformer T1. The secondary winding Ns and the auxiliary winding Nn are configured to differ in a winding direction with respect to the primary winding Np (what is called a flyback coupling). After the FET 1 is turned off (duration from t2 to t3), a positive pulse voltage is induced in the secondary winding Ns and the auxiliary winding Nn. The pulse voltage induced in the secondary winding Ns is rectified and smoothed by a secondary rectifier diode D3 and a secondary smoothing capacitor C4, and becomes a nearly constant output voltage Vout-h.

In this case, when forward voltage of the secondary rectifier diode D3 is Vfd3, the above-described voltage Vcl is approximately expressed by the following equation using the Vout-h.

$${V}_{el} ≅ ( {V}_{out - h} + {V}_{fd 3} ) \cdot \frac{{N}_{p}}{{N}_{s}} \qquad ( 1 )$$

On the other hand, a positive pulse voltage Vnnh induced in the Nn is approximately expressed by the following equation using the Vout-h.

$${V}_{nnh} ≅ ( {V}_{out - h} + {V}_{fd 3} ) \cdot \frac{{N}_{n}}{{N}_{s}} \qquad ( 2 )$$

The Vnnh is rectified and smoothed by a diode D2 and a capacitor C3, and is supplied to the control unit CNT1 as a power source voltage Vcc. From that time onward, the control unit CNT1 continues operation by the power source voltage Vcc. In this case, when a forward voltage of the diode D2 is a Vfd2, the power source voltage Vcc is approximately expressed by the following equation.

$${V}_{cc} ≅ {V}_{nnh} - {V}_{fd 2} ≅ ( {V}_{out - h} + {V}_{fd 3} ) \cdot \frac{{N}_{n}}{{N}_{s}} - {V}_{fd 2} \qquad ( 3 )$$

An electric current “If” flowing through the Ns decreases linearly, and becomes zero in due time (t3). Then, the drain-source voltage Vds begins to slowly decline (duration from t3 to t4). The declining voltage waveform is an LC resonance phenomenon between the inductance Lp of the primary winding Np and the capacitance Cr1 of the primary resonant capacitor C2. A resonance frequency f0, a resonance period T0, and an initial amplitude A0 of the declining voltage waveform are approximately expressed by the following equation.

$$\begin{matrix}{f}_{0} ≅ \frac{1}{2 π \sqrt{{L}_{p} \cdot {C}_{r 1}}} & ( 4 ) \\ {T}_{0} ≅ 2 π \sqrt{{L}_{p} \cdot {C}_{r 3}} & ( 5 ) \\ {A}_{0} ≅ {V}_{cl} & ( 6 )\end{matrix}$$

Now, the drain-source voltage Vds becomes a similar shape to that of an anode voltage Vnn of the diode D2. The anode voltage Vnn is supplied to the control unit CNT1.

The control unit CNT1 detects a time (t4) when the anode voltage Vnn is at a falling edge, and becomes zero, and turns on the FET 1 after the elapse of a predetermined time, from a timing t4 onward. As described above, it is a feature of the pseudo-resonance converter that the switching loss or radiation noise may be reduced, by turning on the FET 1 at a time when the drain-source voltage Vds of the FET 1 drops to the lowest.

A duration Δt from t3 to t4, and a duration Δt from t4 to t5 in FIG. 11 are nearly ¼ cycle of the above-described resonance period T0, and are expressed by the following equation.

$$Δ t ≅ \frac{{T}_{0}}{4} ≅ \frac{π \sqrt{{L}_{p} \cdot {C}_{r 1}}}{2} \qquad ( 7 )$$

Therefore, by turning on the FET 1 after the elapse of Δt, from the timing t4, the FET 1 may be turned on at the lowest point of the LC resonance voltage (t5). In FIGS. 13A and 13B, the FET 1 is turned on, while the drain-source voltage Vds falls below zero, and a body diode D1 of the FET 1 is conduction state. A switching operation performed at the time point when the drain-source voltage Vds is near zero, in this manner, is generally called zero volt switching (ZVS). The switching loss or radiation noise during turn-on of the FET 1 may be significantly reduced by performing the zero volt switching.

Furthermore, when the FET 1 is turned on (from t5 onward), again, the drain current Id begins to flow through the FET 1 via the primary winding Np of the transformer T1. In this case, a negative pulse voltage is induced in the primary winding Ns and the auxiliary winding Nn. A negative pulse voltage Vnnl induced in the auxiliary winding Nn is approximately expressed by the following equation using the Vh.

$${V}_{nnl} ≅ {V}_{h} \cdot \frac{{N}_{n}}{{N}_{p}} \qquad ( 8 )$$

From that time onward, the above-described operation during the duration from t0 to t5 is repeated and the switching operation is continued, and thus a stable voltage is output. Japanese Patent Application Laid-Open 2002-315330 discusses a pseudo-resonance converter which performs the switching operation as described above.

However, there is a problem as will be described below in the above-described pseudo-resonance converter. Nowadays, reduction of power consumption (also referred to as standby power) while an electronic device is inoperative state, what is called, a standby state, is strongly demanded. In an electronic device mounting the above-described pseudo-resonance converter thereon, is also provided a normal operation during which an electronic device is operative (hereinafter, also referred to as a normal mode) and a power-saving operation during which the electronic device is inoperative (hereinafter, referred to as a power-save mode). In the power-save mode, a standby power is reduced by lowering an output voltage from the pseudo-resonance converter.

FIG. 12 illustrates a circuit of the pseudo-resonance converter that lowers an output voltage to reduce the standby power. In FIG. 12, an output varying circuit including resistors (Ra, Rb, Rc, and R8) and an FET 2 is added to the pseudo-resonance converter illustrated in FIG. 10. A power-save signal (hereinafter, referred to as a /PSAVE signal) is supplied to the output varying circuit, from a central processing unit (CPU) 1 serving as a controller of the electronic device. The CPU 1 causes the electronic device to shift from the normal mode to the power-save mode using the /PSAVE signal. The CPU 1, when setting the electronic device to the normal mode, switches the /PSAVE signal to a High level (hereinafter, referred to as a H-level), and when setting the electronic device to the power-save mode, switches the /PSAVE signal to a Low level (hereinafter, referred to as a L-level).

The /PSAVE signal is supplied to the FET 2. In a case of the normal mode, namely, when the /PSAVE signal is at the H-level, the FET 2 is turned on, and the resistor Rb and the resistor Rc are connected in parallel with each other. A voltage obtained by dividing output voltage by the resistor Ra and the parallel resistors (Rb//Rc) is consequently supplied to a ref terminal of a shunt regulator IC1. Therefore, when a reference voltage of the shunt regulator is Vref, the output voltage Vout-h in the normal mode is approximately expressed by the following equation.

$${V}_{out - h} ≅ \frac{{R}_{a} + ( {R}_{b} // {R}_{c} )}{( {R}_{b} // {R}_{c} )} \cdot {V}_{ref} \qquad ( 9 )$$

Where, (Rb//Rc) is a parallel resistance value of the Rb and Rc, and is expressed by the following equation.

$${R}_{b} // {R}_{c} = \frac{{R}_{b} \cdot {R}_{c}}{{R}_{b} + {R}_{c}} \qquad ( 10 )$$

On the other hand, in a case of the power-save mode, namely, when the /PSAVE signal is at the L-level, the FET 2 is turned off, and the Rc is separated off. Hence, a voltage supplied to the ref terminal of the shunt regulator IC1 becomes a voltage obtained by dividing the output voltage by Ra and Rb. Therefore, an output voltage Vout-l in the power-save mode is approximately expressed by the following equation.

$${V}_{out - l} ≅ \frac{{R}_{a} + {R}_{b}}{{R}_{b}} \cdot {V}_{ref} \qquad ( 11 )$$

Therefore, the output voltage Vout-l in the power-save mode will drop lower than the output voltage Vout-h in the normal mode.

Now, FIGS. 13A and 13B illustrate operation waveforms of the pseudo-resonance converter in the normal mode and the power-save mode. The operation waveforms in the normal mode in FIG. 13A are similar to those in FIG. 11. In the operation waveforms in the power-save mode in FIG. 13B, when the output voltage drops from the Vout-h down to the Vout-l, Vcl drops as approximately expressed by the following equation.

$${V}_{cl} ≅ ( {V}_{out - l} + {V}_{fd 3} ) \cdot \frac{{N}_{p}}{{N}_{s}} \qquad ( 12 )$$

Furthermore, when the FET 1 is turned off, the positive pulse voltage Vnnh induced in the auxiliary winding Nn drops as approximately expressed by the following equation.

$${V}_{nnh} ≅ ( {V}_{out - l} + {V}_{fd 3} ) \cdot \frac{{N}_{n}}{{N}_{s}} \qquad ( 13 )$$

Since the Vnnh drops, the power source voltage Vcc of the control unit CNT1 will drop as approximately expressed by the following equation.

$${V}_{cc} ≅ {V}_{nnh} - {V}_{fd 2} ≅ ( {V}_{out - l} + {V}_{fd 3} ) \cdot \frac{{N}_{n}}{{N}_{s}} - {V}_{fd 2} \qquad ( 14 )$$

As described above, when the output voltage is lowered, in the power-save mode, the power source voltage Vcc of the control unit CNT1 will be also lowered. On the other hand, in order to stably operate the control unit CNT1, it is necessary to maintain the power source voltage Vcc above a certain value. As a result, limitations automatically occur on amounts of the output voltage drop. In short, there is a problem that it is difficult to perform additional reduction of power consumption in the power-save mode.

### SUMMARY OF THE INVENTION

One disclosed aspect of the embodiments is directed to enabling additional reduction of power consumption in a standby state, in a pseudo-resonance converter.

According to an aspect of the embodiments, a switching power source includes a transformer including a primary winding, a secondary winding having a reverse winding direction relative to that of the primary winding, and an auxiliary winding having the same winding direction relative to that of the primary winding, a switching unit configured to perform switching of an electric current input into the primary winding of the transformer, and a control unit configured to operate by being supplied with voltage from the auxiliary winding. The control unit controls a drive timing of the switching unit by using voltage supplied from the auxiliary winding, to control voltage generated in the secondary winding.

Further features and aspects of the embodiments will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the embodiments and, together with the description, serve to explain the principles of the embodiments.

FIG. 1 is a circuit diagram of a pseudo-resonance converter according to a first exemplary embodiment.

FIG. 2 is an internal circuit diagram of a control unit of the pseudo-resonance converter according to the first exemplary embodiment.

FIGS. 3A and 3B illustrate operational waveforms of the pseudo-resonance converter according to the first exemplary embodiment.

FIG. 4 is a circuit diagram of the pseudo-resonance converter according to a second exemplary embodiment.

FIG. 5 is an internal circuit diagram of a control unit of the pseudo-resonance converter according to the second exemplary embodiment.

FIGS. 6A and 6B illustrate operational waveforms of the pseudo-resonance converter according to the second exemplary embodiment.

FIG. 7 is a circuit diagram of the pseudo-resonance converter according to a third exemplary embodiment.

FIG. 8 is an internal circuit diagram of a control unit of the pseudo-resonance converter according to a third exemplary embodiment.

FIGS. 9A and 9B illustrate operational waveforms of the pseudo-resonance converter according to the third exemplary embodiment.

FIG. 10 is a circuit diagram of a conventional pseudo-resonance converter.

FIG. 11 illustrates operational waveforms of the conventional pseudo-resonance converter.

FIG. 12 is a circuit diagram of the conventional pseudo-resonance converter.

FIGS. 13A and 13B illustrate operation waveforms of the conventional pseudo-resonance converter.

FIGS. 14A and 14B illustrate application examples of the pseudo-resonance converter.

### DESCRIPTION OF THE EMBODIMENTS

Various exemplary embodiments, features, and aspects of the embodiments will be described in detail below with reference to the drawings. One disclosed feature of the embodiments may be described as a process which is usually depicted as a flowchart, a flow diagram, a timing diagram, a structure diagram, or a block diagram. Although a flowchart or a timing diagram may describe the operations or events as a sequential process, the operations may be performed, or the events may occur, in parallel or concurrently. An operation in a flowchart may be optional. In addition, the order of the operations or events may be re-arranged. A process is terminated when its operations are completed. A process may correspond to a method, a program, a procedure, a method of manufacturing or fabrication, a sequence of operations performed by an apparatus, a machine, or a logic circuit, etc.

Hereinbelow, configurations and operations of the embodiments will be described. The exemplary embodiments illustrated below are examples, and it is not intended to limit the technical scope of the embodiments only to these exemplary embodiments. Hereinbelow, while referring to the accompanying drawings, modes for implementing the embodiments will be described in detail based on the exemplary embodiments.

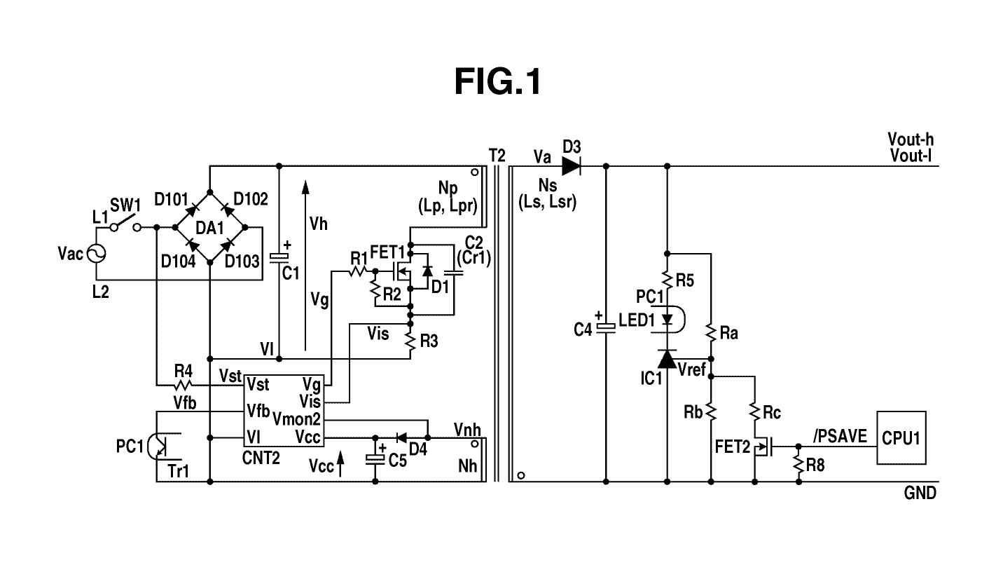

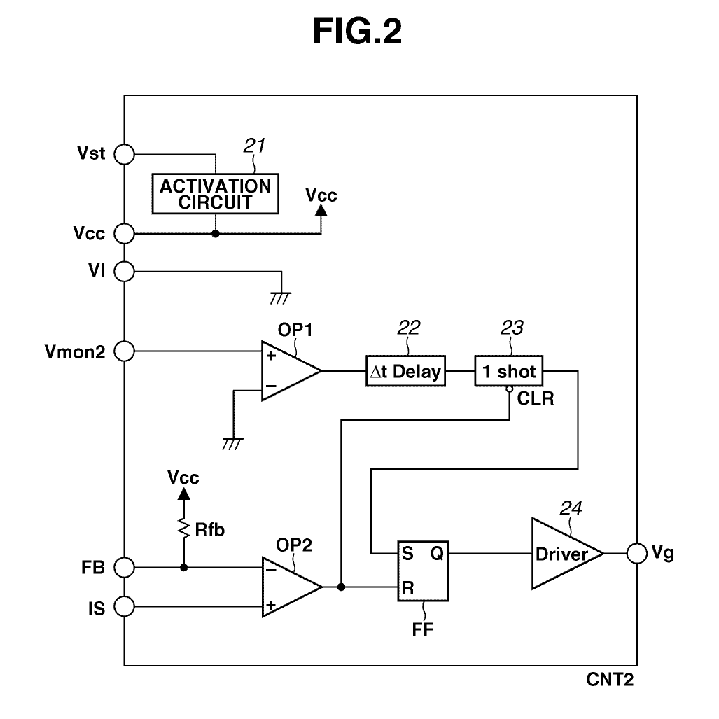

A first exemplary embodiment will be described. FIG. 1 illustrates a circuit diagram of a switching power source of pseudo-resonance type (hereinafter, referred to as a pseudo-resonance converter) according to the first exemplary embodiment. FIG. 2 illustrates an internal circuit of a control module CNT2 (hereinafter, referred to as a control unit CNT2).

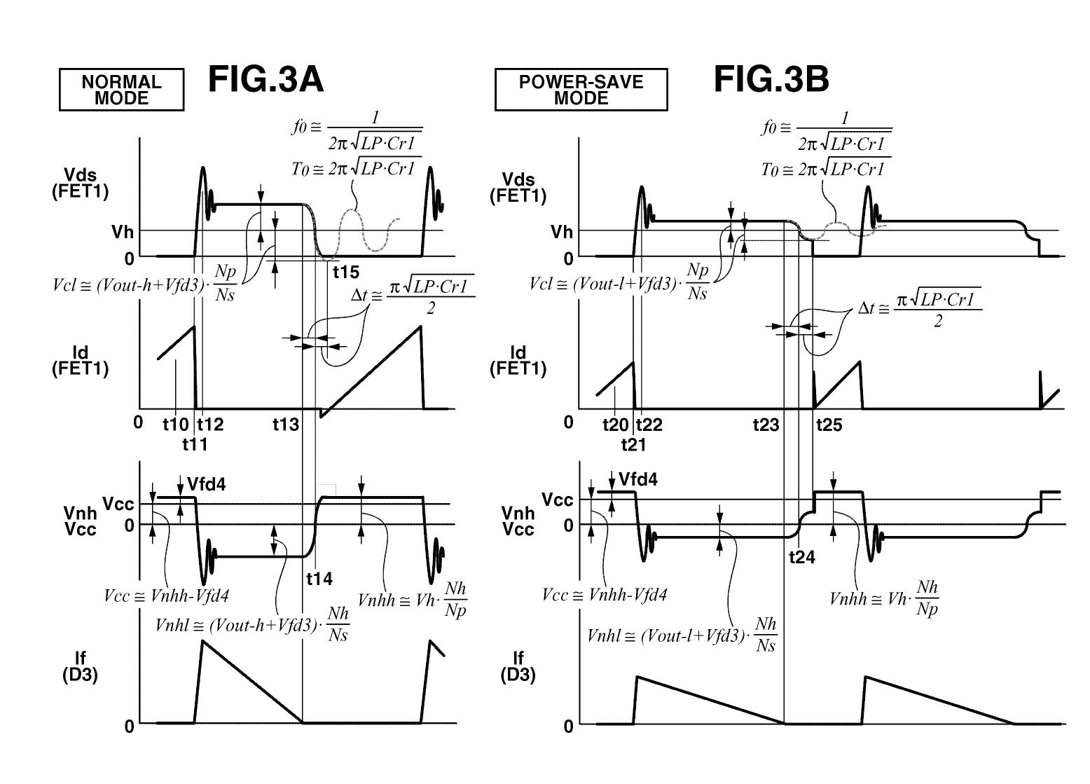

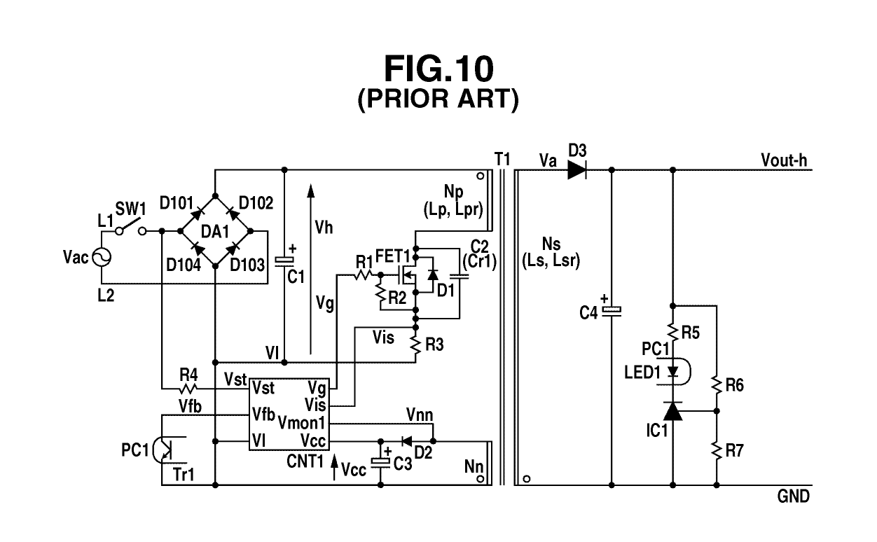

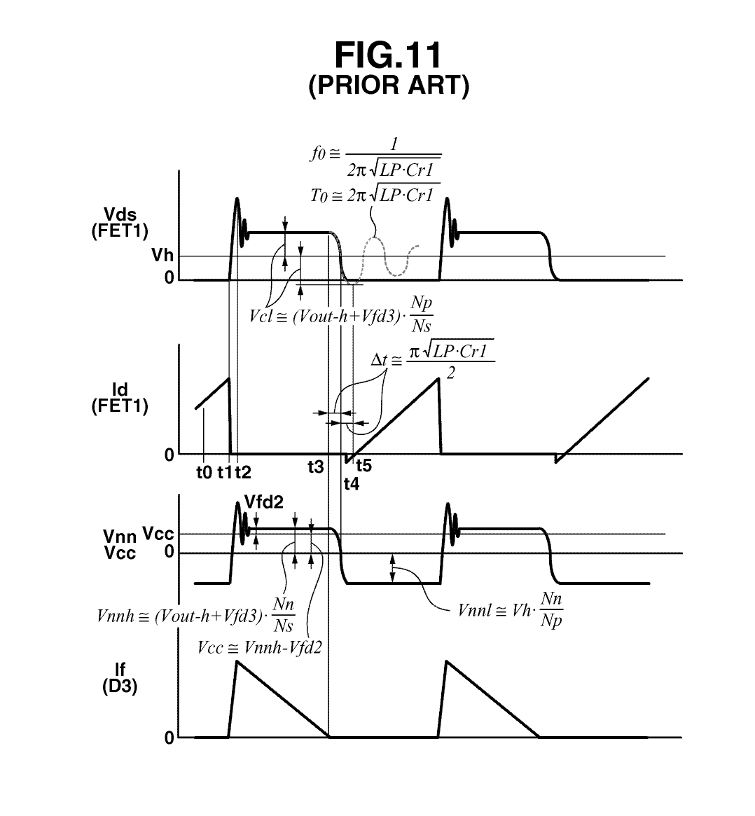

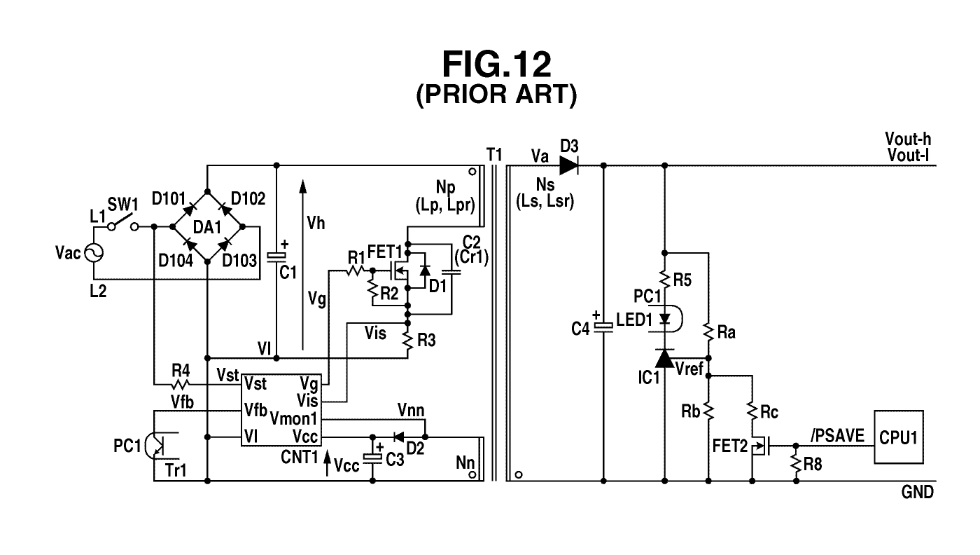

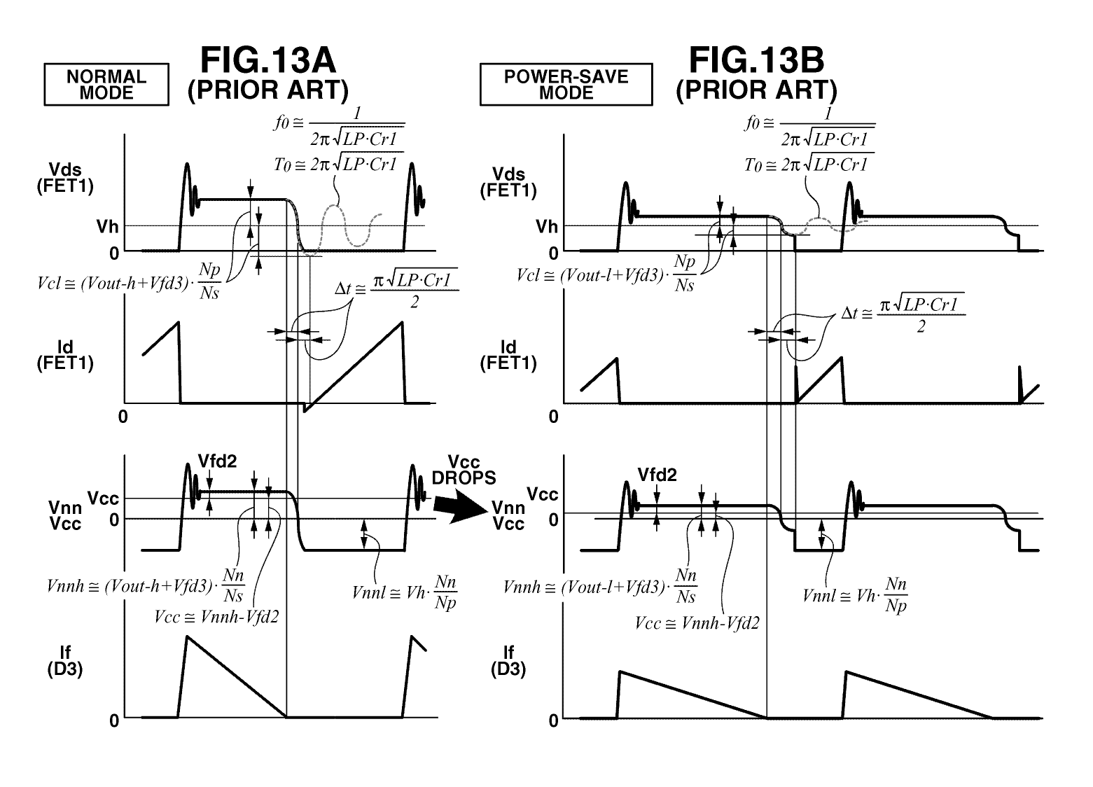

FIG. 3A illustrates operational waveforms in the normal mode of the pseudo-resonance converter. FIG. 3B illustrates operational waveforms in the power-save mode of the pseudo-resonance converter. The first exemplary embodiment has a feature that a configuration of an auxiliary winding of a transformer is different from that in the conventional pseudo-resonance converter explained in the above-described FIG. 10 and FIG. 12.

The first exemplary embodiment has a feature that an auxiliary winding Nh of a transformer T2 is configured to have the same winding direction as that of a primary winding Np of the transformer T2 (what is called, a forward coupling). Further, in the first exemplary embodiment, the pseudo-resonance converter includes a rectification smoothing circuit including the auxiliary winding Nh of the transformer T2, a diode D4 and a capacitor C5. A direct current (DC) voltage generated by the auxiliary winding Nh, the diode D4, and the capacitor C5 is served as a power source voltage Vcc of the control unit CNT2. Further, the first exemplary embodiment has a feature that the control unit CNT2 detects time when a terminal voltage Vnh of the auxiliary winding Nh becomes zero from negative voltage, and determines a timing when the FET 1 turns on. The same reference numerals are designated to similar components to those in the above-described FIG. 10.

The pseudo-resonance converter in FIG. 1 includes an output varying circuit including resistors (Ra, Rb, Rc, and R8) and an FET 2. A power-save signal (hereinafter, referred to as a /PSAVE signal) is supplied to the output varying circuit from a CPU 1 of a controller of an electronic device. The CPU 1 shifts the electronic device from the normal mode to the power-save mode using the /PSAVE signal. The CPU 1 puts the /PSAVE signal to the H-level, when the CPU 1 sets the electronic device to the normal mode, and puts the /PSAVE signal to the L-level, when the CPU1 sets the electronic device to the power-save mode.

The /PSAVE signal is supplied to the FET 2. In the normal mode, namely, when the /PSAVE signal is at the H-level, the FET 2 is turned on, and the resistor Rb and the resistor Rc are connected in parallel with each other. A voltage obtained by dividing output voltage from the pseudo-resonance converter by the resistor Ra and the parallel resistors (Rb//Rc) is consequently supplied to a ref terminal of a shunt regulator IC1. Therefore, when a reference voltage of the shunt regulator is Vref, an output voltage Vout-h in the normal mode is approximately expressed by following equation.

$${V}_{out - k} ≅ \frac{{R}_{a} + ( {R}_{b} // {R}_{c} )}{( {R}_{b} // {R}_{c} )} \cdot {V}_{ref} \qquad ( 15 )$$

Where, (Rb//Rc) is a parallel resistance value of the Rb and Rc, and is expressed by the following equation.

$${R}_{b} // {R}_{c} = \frac{{R}_{b} \cdot {R}_{c}}{{R}_{b} + {R}_{c}} \qquad ( 16 )$$

On the other hand, in the power-save mode, namely, when the /PSAVE signal is at the L-level, the FET 2 is turned off, and the Rc is separated off. Hence, voltage supplied to the ref terminal of the shunt regulator IC1 is set to the voltage obtained by dividing the output voltage by the Ra and the Rb. Therefore, an output voltage Vout-l in the power-save mode is approximately expressed by following equation.

$${V}_{out - l} ≅ \frac{{R}_{a} + {R}_{b}}{{R}_{b}} \cdot {V}_{ref} \qquad ( 17 )$$

Therefore, the output voltage Vout-l in the power-save mode will drop lower than the output voltage Vout-h in the normal mode.

FIGS. 3A and 3B illustrate operational waveforms of the pseudo-resonance converter in the normal mode and the power-save mode. In FIGS. 3A and 3B, the drain voltage Vds of the FET 1 for a duration during which the FET 1 is turned off becomes a nearly constant voltage Vh+Vcl (duration from t12 to t13). The secondary winding Ns, and the auxiliary winding Nh, in addition to the primary winding Np are wound over the transformer T2. The secondary winding Ns is configured to differ in a winding direction, with respect to the primary winding Np (what is called a flyback coupling). Since the time when the FET 1 is turned off (duration from t12 to t13), a positive pulse voltage is induced in the secondary winding Ns.

On the other hand, the auxiliary winding Nh is configured to have the same winding direction, with respect to the primary winding Np (what is called, a forward coupling). Since the time when the FET 1 is turned off (duration from t12 to t13), a negative pulse voltage is induced on the auxiliary winding Nh. A pulse voltage induced in the secondary winding Ns is rectified and smoothed by a secondary rectifier diode D3 and a secondary smoothing capacitor C4 and becomes a nearly constant output voltage Vout-h.

In this case, when a forward voltage of the diode D3 is Vfd3, the above-described voltage Vcl is approximately expressed by the following equation using the Vout-h.

$${V}_{cl} ≅ ( {V}_{out - h} + {V}_{fd 3} ) \cdot \frac{{N}_{p}}{{N}_{s}} \qquad ( 18 )$$

On the other hand, a negative pulse voltage Vnhl induced in the auxiliary winding Nh is approximately expressed by the following equation using the Vout-h.

$${V}_{nhl} ≅ ( {V}_{out - h} + {V}_{fd 3} ) \cdot \frac{{N}_{h}}{{N}_{s}} \qquad ( 19 )$$

An electric current If flowing through the secondary winding Ns decreases linearly, and becomes zero in due time (timing at t13). Then, the drain-source voltage Vds of the FET 1 begins to slowly decline (duration from t13 to t14). The declining voltage waveform is the LC resonance phenomenon between the primary winding Np (inductance Lp) and a capacitor C2 (capacitance Cr1), and a frequency f0, a period T0, and an initial amplitude A0 of the declining voltage waveform are approximately expressed by the following equations. Supposing that the FET 1 is not turned on again, from that time onwards, the drain-source voltage Vds will continue the LC resonance phenomenon at the frequency f0, as indicated with dashed lines of voltage waveforms in FIGS. 3A and 3B.

$$\begin{matrix}{f}_{0} ≅ \frac{1}{2 π \sqrt{{L}_{P} \cdot {C}_{r 1}}} & ( 20 ) \\ {T}_{0} ≅ 2 π \sqrt{{L}_{P} \cdot {C}_{r 1}} & ( 21 ) \\ {A}_{0} ≅ {V}_{cl} & ( 22 )\end{matrix}$$

Then, the drain-source voltage Vds becomes a similar shape to a waveform obtained by reversing from positive to negative and vice-versa, a voltage waveform of the terminal voltage Vnh of the auxiliary winding Nh. The terminal voltage Vnh is supplied to a Vmon2 terminal of the control unit CNT2. As illustrated in FIG. 2, the control unit CNT2 is configured to detect a timing (t14) when the terminal voltage Vnh supplied to the Vmon2 terminal becomes zero from negative voltage, and to turn on the FET 1 after the elapse of a predetermined time, from the time t14 onwards. It is a feature of the pseudo-resonance converter that the switching loss or radiation noise is reduced, by turning on the FET 1 at the timing when the drain-source voltage Vds of the FET 1 has dropped to lowest, through the use of this configuration.

Here, the control module CNT2 in FIG. 2 will be described. A Vst terminal of the control unit CNT2 is an activating power source terminal, and is connected to a Vcc terminal via an activation circuit 21 inside the control unit CNT2. The activation circuit 21 receives a voltage supply from the outside of the control unit CNT2 and charges an external capacitor connected to a Vcc terminal. In FIG. 1, a voltage from a commercial AC power source is supplied to the Vst terminal via an activation resistor R4. Further, the capacitor C5 is connected to the Vcc terminal. The voltage from the commercial AC power source is a voltage from the outside, and the capacitor C5 corresponds to the external capacitor.

When a terminal voltage of the external capacitor C5 exceeds a predetermined value, the control unit CNT2 starts operation. Further, when the terminal voltage of the external capacitor C5 exceeds the predetermined value, the activation circuit cuts off connection of the Vst terminal and the Vcc terminal, and cuts off power supply from the outside.

The Vmon2 terminal is a terminal that determines a timing when to turn on the FET 1 on the outside. At the timing when voltage supplied to the Vmon2 terminal becomes zero from negative voltage, an output of an internal operational amplifier OP1 changes from the L-level to the H-level. A Δt Delay module 22, after Δt duration from that timing, sets up an RS flip-flop FF via a module 23. Then, an output Q of the RS flip-flop FF changes from the L-level to the H-level. Accordingly, a Vg terminal which is an output of a Driver 24 serving as a driver circuit changes from the L-level to the H-level. A gate terminal of the FET 1 on the outside is connected to the Vg terminal. Hence, the FET 1 on the outside turns on.

Further, an FB terminal and an IS terminal are terminals that determine an off-timing of the FET 1 on the outside. A feedback voltage is supplied to the FB terminal from the outside. On the other hand, a voltage which has detected a drain current of the FET 1 is supplied to the IS terminal from the outside. When the drain current of the FET 1 on the outside increases, and accordingly a voltage of the IS terminal increases to reach a voltage of the FB terminal, an output of an internal operational amplifier OP2 changes from the L-level to the H-level.

The output of the operational amplifier OP2 resets the module 23, and puts its output to the L-level.

Further, an output of the operational amplifier OP2 resets the RS flip-flop FF, and puts an output Q to the L-level.

Accordingly, the Vg terminal which is an output of the Driver 24 serving as a driver circuit changes from the H-level to the L-level. A gate terminal of the FET 1 on the outside is connected to the Vg terminal. Hence, the FET 1 on the outside turns off.

The durations Δt from t13 to t14, and from t14 to t15 are approximately ¼ cycle of the period T0 in the above-described LC resonance phenomenon, and take a known value as expressed by the following equation.

$$Δ t ≅ \frac{{T}_{0}}{4} ≅ \frac{π \sqrt{{L}_{p} \cdot {C}_{r 1}}}{2} \qquad ( 23 )$$

Therefore, by turning on the FET 1, after the elapse of Δt from the time t14, the FET 1 may be turned on at the lowest point of the LC resonance voltage (Vds) (t15). In FIGS. 3A and 3B, the FET 1 is turned on while the drain-source voltage Vds of the FET 1 falls below zero, and a body diode D1 of the FET 1 is conduction state. A switching operation performed at a time point when the drain-source voltage Vds is near zero, in this manner, is referred to as zero volt switching (hereinafter, referred to as ZVS). By performing ZVS, the switching loss or radiation noise during turn-on of the FET 1 may be reduced significantly.

When the FET 1 is turned on (from the t15 onward), again, a drain current Id begins to flow through the FET 1 via the primary winding Np of the transformer T2. At this time, a negative pulse voltage is induced in the secondary winding Ns. On the other hand, a positive pulse voltage is induced in the auxiliary winding Nh. The positive pulse voltage Vnhh induced in the auxiliary winding Nh is approximately expressed by the following equation using the Vh.

$${V}_{nhh} ≅ {V}_{h} \cdot \frac{{N}_{h}}{{N}_{p}} \qquad ( 24 )$$

This Vnhh is rectified and smoothed by the diode D4 and the capacitor C5, and is supplied to the CNT2 as the power source voltage Vcc. From that time onward, the control unit CNT2 continues operation by the Vcc. In this case, when a forward voltage of the diode D4 is Vfd4, the Vcc is approximately expressed by the following equation.

$${V}_{cc} ≅ {V}_{nhh} - {V}_{fd 4} ≅ {V}_{h} \cdot \frac{{N}_{h}}{{N}_{p}} - {V}_{fil 4} \qquad ( 25 )$$

After that, the above-described operations during the duration from t10 to t15 will be repeated.

Next, FIG. 3B illustrates operational waveforms of the pseudo-resonance converter in the power-save mode. In the power-save mode, when the output voltage drops from the Vout-h to the Vout-l, the Vcl drops as approximately expressed by the following equation.

$${V}_{cl} ≅ ( {V}_{out - 1} + {V}_{fd 3} ) \cdot \frac{{N}_{p}}{{N}_{s}} \qquad ( 26 )$$

Furthermore, during turn-off of the FET 1 (duration from t22 to t23), the negative pulse voltage Vnhl induced in the auxiliary winding Nh drops as approximately expressed by the following equation.

$${V}_{nhl} ≅ ( {V}_{out - 1} + {V}_{fd 3} ) \cdot \frac{{N}_{h}}{{N}_{s}} \qquad ( 27 )$$

On the other hand, during turn-on of the FET 1 (from the time t25 onward), the positive pulse voltage Vnh induced in the auxiliary winding Nh is approximately expressed by the following equation, using the Vh.

$${V}_{nhh} ≅ {V}_{h} \cdot \frac{{N}_{h}}{{N}_{p}} \qquad ( 28 )$$

Therefore, the power source voltage Vcc to the control unit CNT2 will be approximately expressed by the following equation.

$${V}_{oc} ≅ {V}_{nhh} - {V}_{fil 4} ≅ {V}_{h} \cdot \frac{{N}_{h}}{{N}_{p}} - {V}_{fil 4} \qquad ( 29 )$$

Here, as may be seen from the equation (29), the power source voltage Vcc is not dependent on a value of the Vout-l. Hence, in the power-save mode, even when the output voltage is lowered, the power source voltage Vcc of the control unit CNT2 will not drop. Therefore, it becomes possible to further lower the output voltage in the power-save mode. Accordingly, it becomes possible to further reduce power consumption in the power-save mode.

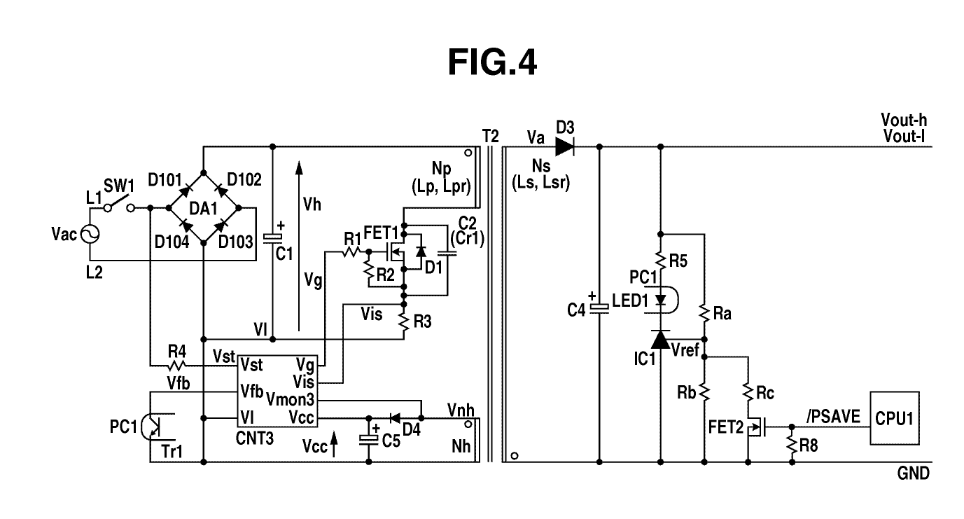

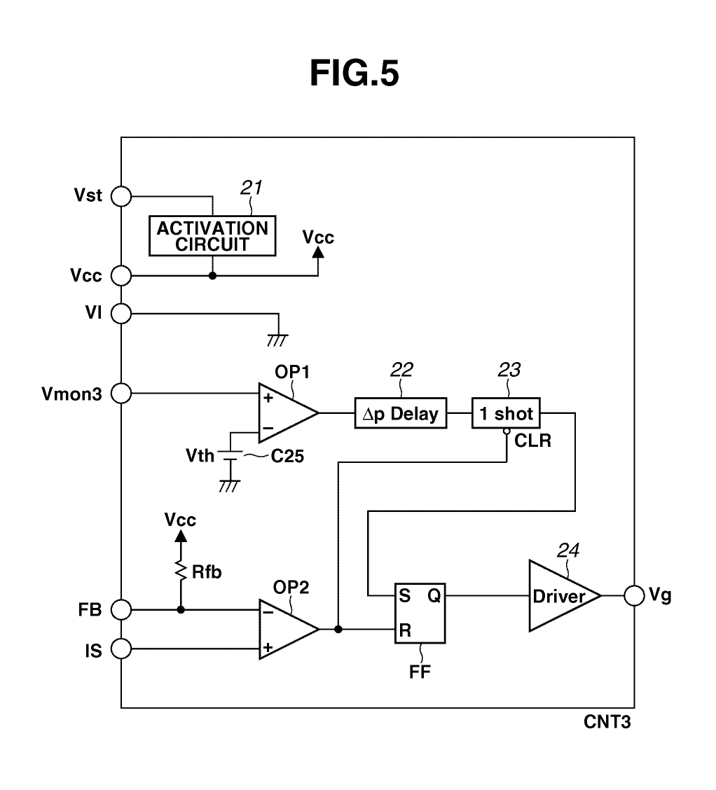

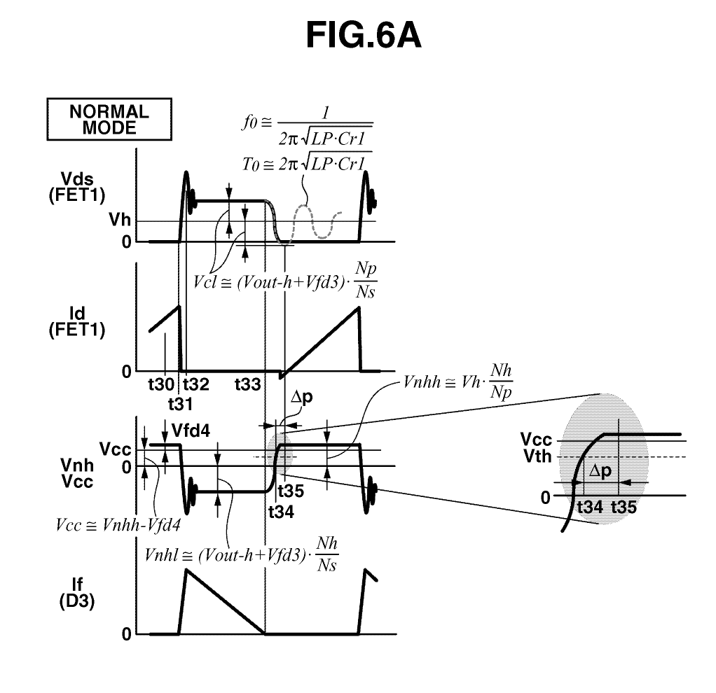

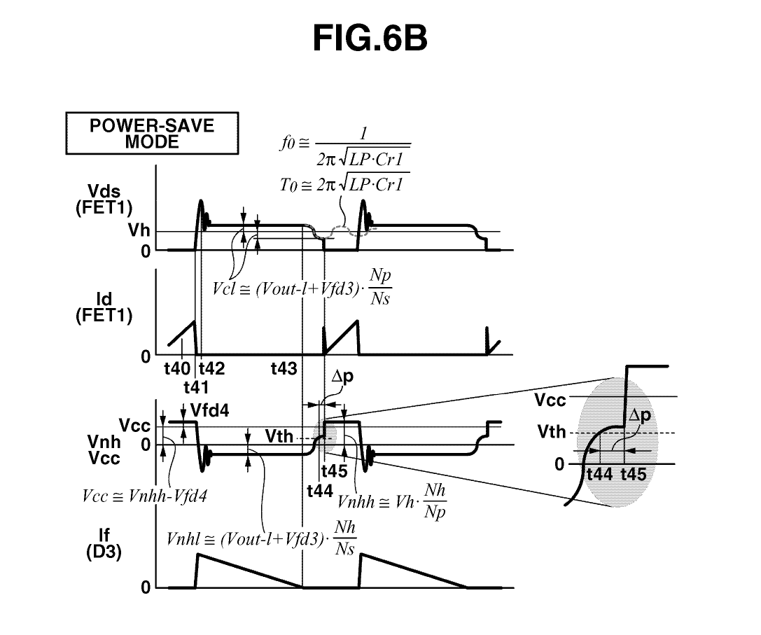

Next, a second exemplary embodiment will be described. FIG. 4 illustrates a circuit of a pseudo-resonance converter according to a second exemplary embodiment. FIG. 5 illustrates an internal circuit of a control module CNT3 (hereinafter, referred to as a control unit CNT3). FIG. 6A illustrates operational waveforms in the normal mode of the pseudo-resonance converter. FIG. 6B illustrates operational waveforms in the power-save mode of the pseudo-resonance converter. In the second exemplary embodiment, a configuration of the auxiliary winding of the transformer is different from that in the conventional pseudo-resonance converter illustrated in FIG. 10 and FIG. 12. It is a feature that the auxiliary winding Nh of the transformer T2 according to the second exemplary embodiment is configured to have the same winding direction as that of the primary winding Np of the transformer T2 (what is called, a forward coupling).

Further, in the second exemplary embodiment, a rectification smoothing circuit including the auxiliary winding Nh of the transformer T2, the diode D4 and the capacitor C5. DC voltage generated by the auxiliary winding Nh, the diode D4, and the capacitor C5 is served as the power source voltage Vcc of the control unit CNT3. Further, it is a feature that the control unit CNT3 detects time when the terminal voltage Vnh of the auxiliary winding Nh is at a rising edge, and reaches a predetermined voltage value, and determines on-timing of the FET 1.

In the first exemplary embodiment described above, the on-timing of the FET 1 is determined by detecting time when the terminal voltage Vnh of the auxiliary winding Nh becomes zero from negative voltage. In the second exemplary embodiment, the different from the first exemplary embodiment is in that the timing at which the Vnh becomes the predetermined voltage value is detected. The second exemplary embodiment has an advantage that, by setting a predetermined voltage value in the vicinity of the Vnh voltage when the LC resonance voltage reaches the lowest point, the timing of the lowest point of the LC resonance voltage may be seized more accurately and thereby the FET 1 may be turned on. The same numerical numerals are designated to similar components to those in the above-described FIG. 10 or FIG. 1 in the first exemplary embodiment.

The pseudo-resonance converter in FIG. 4 includes an output varying circuit including the resistor Ra, the resistor Rb, the resistor Rc, the resistor R8, and the FET 2. In the output varying circuit, the /PSAVE signal is supplied, from the CPU 1 of the controller of the electronic device. The CPU 1 shifts the electronic device from the normal mode to the power-save mode, using the /PSAVE signal. The CPU 1, when setting the electronic device to the normal mode, puts the /PSAVE signal to the H-level, and when setting the device to the power-save mode, puts the /PSAVE signal to the L-level.

The /PSAVE signal is supplied to the FET 2. In a case of the normal mode, namely, when the /PSAVE signal is at the H-level, the FET 2 is turned on, and the resistor Rb and the resistor Rc are connected in parallel with each other. A voltage obtained by dividing the output voltage by the resistor Ra and the parallel resistors (Rb//Rc) is consequently supplied to the ref terminal of the shunt regulator IC1.

Therefore, when a reference voltage of the shunt regulator is Vref, the output voltage Vout-h in the normal mode is approximately expressed by following equation.

$${V}_{out - h} ≅ \frac{{R}_{a} + ( {R}_{b} // {R}_{c} )}{( {R}_{b} // {R}_{c} )} \cdot {V}_{ref} \qquad ( 30 )$$

Where, (Rb//Rc) is a parallel resistance value of the Rb and Rc, and is expressed by the following equation.

$${R}_{b} // {R}_{c} = \frac{{R}_{b} \cdot {R}_{c}}{{R}_{b} + {R}_{c}} \qquad ( 31 )$$

On the other hand, in the power-save mode, namely, when the /PSAVE signal is at the L-level, the FET 2 is turned off, and the resistor Rc is separated off. Hence, a voltage supplied to the ref terminal of the shunt regulator IC1 becomes a voltage obtained by dividing the output voltage by the resistor Ra and the resistor Rb. Therefore, the output voltage Vout-l in the power-save mode is approximately expressed by the following equation.

$${V}_{out - 1} ≅ \frac{{R}_{a} + {R}_{b}}{{R}_{b}} \cdot {V}_{ref} \qquad ( 32 )$$

Therefore, the output voltage Vout-l in the power-save mode will drop lower than the output voltage Vout-h in the normal mode.

Now, FIG. 6A illustrates operational waveforms of the pseudo-resonance converter in the normal mode. The drain-source voltage Vds of the FET 1 becomes a nearly constant voltage Vh+Vcl, for a duration during which the FET 1 is turned off (duration from t32 to t33). The secondary winding Ns and the auxiliary winding Nh, in addition to the primary winding Np are wound over the transformer T2. The secondary winding Ns is configured to differ in a winding direction with respect to the auxiliary winding Np (what is called, a flyback coupling). Since the time when the FET 1 is turned off (duration from t32 to t33), the positive pulse voltage is induced in the secondary winding Ns.

On the other hand, the auxiliary winding Nh is configured to have the same winding direction, with respect to the primary winding Np (what is called, a forward coupling). Since the time when the FET 1 is turned off (duration from t32 to t33), the negative pulse voltage is induced in the auxiliary winding Nh. A pulse voltage induced in the secondary winding Ns is rectified and smoothed by the secondary rectifier diode D3 and the secondary smoothing capacitor C4, and becomes the nearly constant output voltage Vout-h. In this case, when a forward voltage of the secondary rectifier diode D3 is Vfd3, the above-described voltage Vcl is approximately expressed by the following equation, using the Vout-h.

$${V}_{cl} ≅ ( {V}_{out - h} + {V}_{fd 3} ) \cdot \frac{{N}_{p}}{{N}_{s}} \qquad ( 33 )$$

On the other hand, a negative pulse voltage Vnhl induced in the auxiliary winding Nh is approximately expressed by the following equation, using the Vout-h.

$${V}_{nhl} ≅ ( {V}_{out - h} + {V}_{fd 3} ) \cdot \frac{{N}_{h}}{{N}_{s}} \qquad ( 34 )$$

An electric current If flowing through the secondary winding Ns decreases linearly, and becomes zero in due time (timing at t33). Then, the voltage drain-source voltage Vds of the FET 1 begins to slowly decline (duration from t33 to t34). The declining voltage waveform is the LC resonance phenomenon between the primary winding Np (inductance Lp) and the capacitor C2 (capacitance Cr1), and a frequency f0, a cycle T0, and an initial amplitude A0 of the declining voltage waveform are approximately expressed by the following equations. Supposing that the FET 1 is not turned on again from that time onwards, the LC resonance phenomenon will continue at the frequency f0, as illustrated with dashed lines of the voltage waveforms in FIG. 6A.

$$\begin{matrix}{f}_{0} ≅ \frac{1}{2 π \sqrt{{L}_{P} \cdot {C}_{r 1}}} & ( 35 ) \\ {T}_{0} ≅ 2 π \sqrt{{L}_{P} \cdot {C}_{r 1}} & ( 36 ) \\ {A}_{0} ≅ {V}_{d} & ( 37 )\end{matrix}$$

Then, the drain-source voltage Vds becomes a similar shape to a waveform obtained by reversing from positive to negative and vice-versa, a voltage waveform of the terminal voltage Vnh of the auxiliary winding Nh. The terminal voltage Vnh is supplied to a Vmon3 terminal of the control unit CNT3. As illustrated in FIG. 6A, the control unit CNT3 according to the second exemplary embodiment is configured to detect time (t34) when the terminal voltage Vnh supplied to the Vmon3 terminal is at a rising edge, and becomes a predetermined voltage Vth, and to turn on the FET 1 after the elapse of a predetermined time Δp since the time t34.

It is a feature of the pseudo-resonance converter that through the use of this configuration, the switching loss or the radiation noise is reduced by turning on the FET 1 at a time when the Vds has dropped to lowest. In other words, by appropriately setting the specified time Δp, the FET 1 may be turned on at the lowest point of the LC resonance voltage (t35).

Here, the control unit CNT3 in FIGS. 6A and 6B will be described. The control unit CNT3 according to the second exemplary embodiment differs in a configuration of the Vmon terminal, from the control unit CNT2 according to the second exemplary embodiment. Since the other configurations are the same, the descriptions thereof will be omitted.

The Vmon3 terminal determines an on-timing of the FET 1 on the outside. At the timing when voltage supplied to the Vmon3 terminal becomes the predetermined voltage Vth, an output of the internal operational amplifier OP1 changes from the L-level to the H-level. The Δp Delay module 22, after Δp time from the above timing, sets up the RS flip-flop FF via the module 23. Then, the output Q of the RS flip-flop FF changes from the L-level to the H-level. Accordingly, the Vg terminal which is an output of the Driver 24 serving as a driver circuit changes from the L-level to the H-level. A gate terminal of the FET 1 on the outside is connected to the Vg terminal. Hence, the FET 1 on the outside is turned on.

In FIG. 6A, the FET 1 is turned on, while the Vds falls below zero, and the body diode D1 of the FET 1 is conduction state. By performing ZVS in which switching is performed at a time point when the Vds is near zero, in this manner, the switching loss or radiation noise during turn-on of the FET 1 may be significantly reduced. When the FET 1 is turned on (from the time t35 onward), again, the drain current Id begins to flow through the FET 1 via the primary winding Np of the transformer T2. At this time, a negative pulse voltage is induced in the secondary winding Ns. On the other hand, a positive pulse voltage is induced in the auxiliary winding Nh. A positive pulse voltage Vnhh induced in the auxiliary winding Nh is approximately expressed by the following equation, using the Vh.

$${V}_{nhh} ≅ {V}_{h} \cdot \frac{{N}_{h}}{{N}_{p}} \qquad ( 38 )$$

The Vnhh is rectified and smoothed by the diode D4 and the capacitor C5, and is supplied to the control unit CNT3 as the power source voltage Vcc. Since then, the control unit CNT3 continues operation by the power source voltage Vcc. In this case, when a forward voltage of the diode D4 is Vfd4, the power source voltage Vcc is approximately expressed by the following equation.

$${V}_{cc} ≅ {V}_{nhh} - {V}_{fil 4} ≅ {V}_{h} \cdot \frac{{N}_{h}}{{N}_{p}} - {V}_{fd 4} \qquad ( 39 )$$

Since then, operation of the above-described duration from t30 to t35 is repeated.

Next, FIG. 6B illustrates operational waveforms of the pseudo-resonance converter, in the power-save mode. In the power-save mode, when the output voltage drops from the Vout-h to the Vout-l, the Vcl drops as approximately expressed by the following equation.

$${V}_{cl} ≅ ( {V}_{out - l} + {V}_{fd 3} ) \cdot \frac{{N}_{p}}{{N}_{s}} \qquad ( 40 )$$

Furthermore, a negative pulse voltage Vnhl induced in the auxiliary winding Nh, during turn-off of the FET 1 (duration from t42 to t43), drops as approximately expressed by the following equation.

$${V}_{nhl} ≅ ( {V}_{out - 1} + {V}_{fil 3} ) \cdot \frac{{N}_{h}}{{N}_{s}} \qquad ( 41 )$$

On the other hand, during turn-on of the FET 1 (duration from t45 onward), the positive pulse voltage Vnhh induced in the auxiliary winding Nh is approximately expressed by the following equation, using the Vh.

$${V}_{nhh} ≅ {V}_{h} \cdot \frac{{N}_{h}}{{N}_{p}} \qquad ( 42 )$$

Therefore, the power source voltage Vcc of the control unit CNT3 is approximately expressed by the following equation.

$${V}_{cc} ≅ {V}_{nhh} - {V}_{fd 4} ≅ {V}_{h} \cdot \frac{{N}_{h}}{{N}_{p}} - {V}_{fd 4} \qquad ( 43 )$$

Here, as may be seen from the equation (43), the Vcc is not dependent on a value of the Vout-l. Hence, in the power-save mode, even when the output voltage is lowered, the power source voltage Vcc of the CNT3 will not drop. Therefore, it becomes possible to sufficiently lower the output voltage, in the power-save mode, and it becomes possible to sufficiently reduce power consumption, in the power-save mode.

Next, a third exemplary embodiment will be described. In the configuration of the first exemplary embodiment (FIG. 1), the control unit CNT2 detects a timing (t14) when the terminal voltage Vnh of the auxiliary winding Nh is at a rising edge, and becomes zero, and turns on the FET 1 at the timing (t15) when the predetermined duration Δt has elapsed from the timing of t14. Description has been given of the fact that the switching loss or radiation noise of the FET 1 may be reduced, by setting this Δt to a value calculated by the equation (23) given in the first exemplary embodiment, and turning on the FET 1 at the lowest point of the LC resonance voltage.

Incidentally, values of an inductance Lp of the primary winding Np and a capacitance Cr1 of the primary resonant capacitor C2 in the above equation (23) have a certain level of variations in terms of manufacture of parts. Due to the variations of the parts, deviations occur between a value of Δt which is preset for the control unit CNT2, and a value of actual Δt. As a result, there is a possibility that the FET 1 may not be turned on at the lowest point of the LC resonance voltage. If the parts free of variations are selected, occurrence of the deviations may be prevented, but selection of the parts free of variations requires time and effort. The third exemplary embodiment features a configuration for maintaining accuracy of turn-on of the FET 1, even when deviations of the Δt may occur due to variations of the parts.

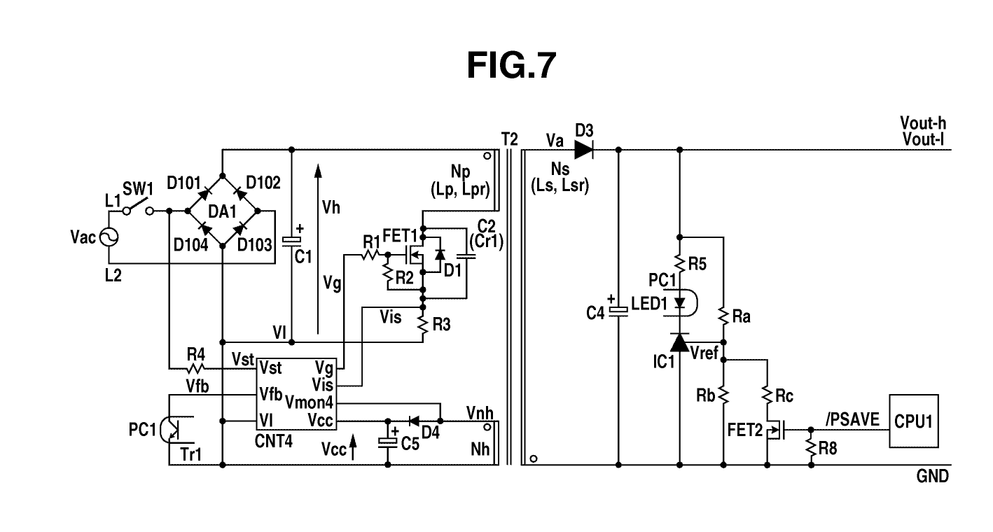

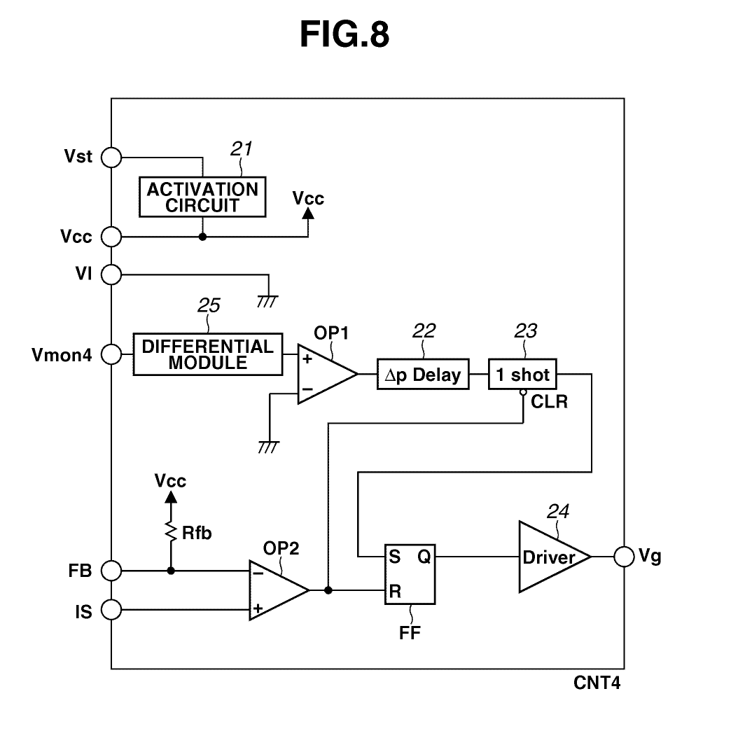

FIG. 7 illustrates a circuit diagram of the pseudo-resonance converter according to the third exemplary embodiment. FIG. 8 illustrates an internal circuit of the control unit CNT4. In the third exemplary embodiment, a configuration of internal circuit of the control unit is different from that in the pseudo-resonance converter of the first exemplary embodiment explained in FIG. 1. The control unit CNT4 has a feature that the FET 1 turns on at the timing when the terminal voltage Vnh of the auxiliary winding Nh is a positive voltage, and, a gradient of the terminal voltage Vnh becomes zero. The same reference numerals are designated to similar components to those in FIG. 1 according to the first exemplary embodiment described above, and descriptions thereof will be omitted.

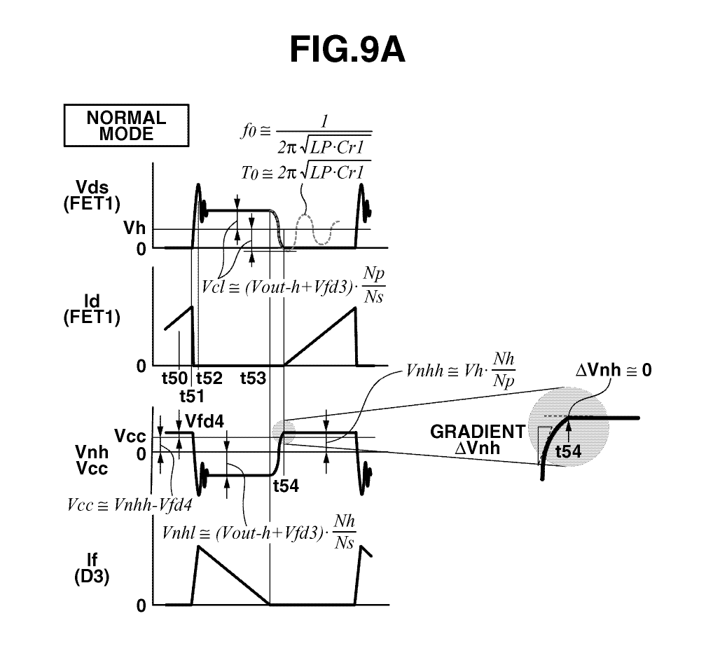

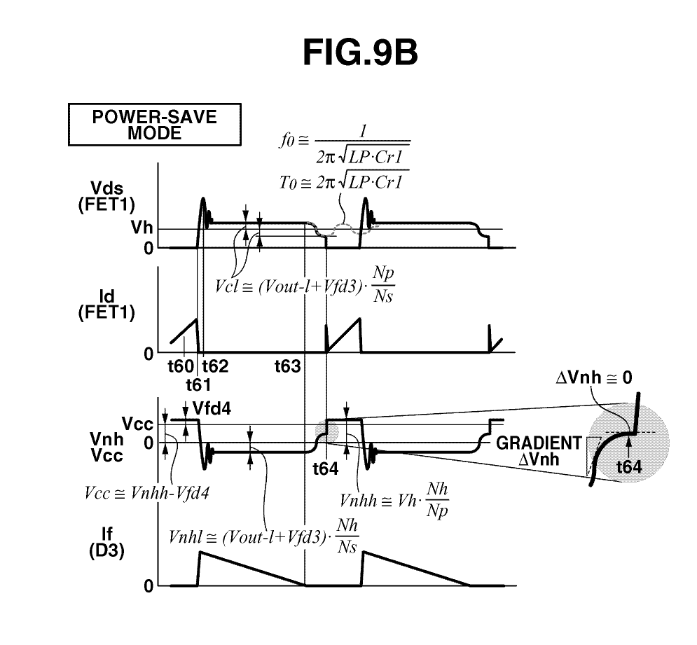

First, FIG. 9A illustrates operational waveforms of the pseudo-resonance converter, in the normal mode. For a duration during which the FET 1 is turned off, the drain-source voltage Vds of the FET 1 becomes the nearly constant voltage Vh+Vcl (duration from t52 to t53). The secondary winding Ns and the auxiliary winding Nh, in addition to the primary winding Np are wound over the transformer T2. The secondary winding Ns is configured to differ in a winding direction, with respect to the primary winding Np (what is called, a flyback coupling). Since the time when the FET 1 is turned off (duration from t52 to t53), a positive pulse voltage is induced in the secondary winding Ns. On the other hand, the auxiliary winding Nh is configured to have the same winding direction, with respect to the primary winding Np (what is called, a forward coupling).

Since the time when the FET 1 is turned off (duration from t52 to t53), a negative pulse voltage is induced in the auxiliary winding Nh. The pulse voltage induced in the secondary winding Ns is rectified and smoothed by the secondary rectifier diode D3 and the secondary smoothing capacitor C4, and becomes the nearly constant output voltage Vout-h. In this case, when a forward voltage of the diode D3 is Vfd3, the above-described voltage Vcl is approximately expressed by the following equation, using the Vout-h.

$${V}_{cl} ≅ ( {V}_{out - h} + {V}_{fd 3} ) \cdot \frac{{N}_{p}}{{N}_{s}} \qquad ( 45 )$$

On the other hand, the negative pulse voltage Vnhl induced in the auxiliary winding Nh is approximately expressed by the following equation, using the Vout-h.

$${V}_{nhl} ≅ ( {V}_{out - h} + {V}_{fd 3} ) \cdot \frac{{N}_{h}}{{N}_{s}} \qquad ( 46 )$$

The electric current If flowing through the auxiliary winding Ns decreases linearly, and becomes zero in due time (t53). Then, the drain-source voltage Vds of the FET 1 begins to slowly decline (duration from t53 to t54). The declining voltage waveform is the LC resonance phenomenon of the inductance Lp of the primary winding Np and the capacitance Cr1 of the capacitor C2, and a frequency f0, a period T0, and an initial amplitude A0 of the declining voltage waveform are approximately expressed by the following equation. Supposing that the FET 1 is not again turned on since that time, the LC resonance phenomenon will continue at the frequency f0, as shown with the dashed line of voltage waveform of the drain-source voltage Vds in FIG. 9A.

$$\begin{matrix}{f}_{0} ≅ \frac{1}{2 π \sqrt{{L}_{p} - {C}_{r 1}}} & ( 47 ) \\ {T}_{0} ≅ 2 π \sqrt{{L}_{p} \cdot {C}_{r 1}} & ( 48 ) \\ {A}_{0} ≅ {V}_{cl} & ( 49 )\end{matrix}$$

The drain-source voltage Vds becomes a similar shape to a waveform obtained by reversing from positive to negative and vice-versa, a voltage waveform of the terminal voltage Vnh of the auxiliary winding Nh. The terminal voltage Vnh is supplied to a Vmon4 terminal of the control unit CNT4. As illustrated in FIG. 8, the Vmon4 terminal is connected to a differential module circuit on the inside of the control unit CNT4. The differential module circuit outputs a positive voltage, in a case where its input voltage is positive, and its gradient is zero. In other cases, the differential module circuit is configured to output a negative voltage. Therefore, the control unit CNT4 turns on the FET 1 at the timing (t54) when the terminal voltage Vnh has a positive voltage, and its gradient becomes zero.

Here, the control unit CNT4 illustrated in FIG. 8 will be described. The control unit CNT4 according to the third exemplary embodiment differs in a configuration of the Vmon terminal, from the control unit 2 according to the first exemplary embodiment. The other components are the same as those according to the first exemplary embodiment, and descriptions thereof will be omitted.

The Vmon4 terminal determines a timing when to turn on the FET 1 on the outside. A voltage supplied to the Vmon4 terminal is supplied to a differential module 25. An output of the differential module 25 is supplied to the internal operational amplifier OP1. Therefore, at the timing when a gradient of a Vmon4 terminal voltage becomes zero, the output of the internal operational amplifier OP1 changes from the L-level to the H-level. After Δp duration from that timing, a Δp Delay module 22 sets up an RS flip-flop FF via 1shot module 23. Then, an output Q of the RS flip-flop FF changes from the L-level to the H-level. Accordingly, a Vg terminal is an output of a Driver 24 serving as a driver circuit changes from the L-level to the H-level. The gate terminal of the FET 1 on the outside is connected to the Vg terminal. Hence, the FET 1 on the outside is turned on.

In FIG. 9A, a gradient of the terminal voltage Vnh becomes zero at the time point when the drain-source voltage Vds falls slightly below zero, and the body diode D1 of the FET 1 is conduction state. At this time point, the FET 1 is turned on. By performing ZVS in which switching is performed at the time point when the drain-source voltage Vds is near zero, in this manner, the switching loss or radiation noise during turn-on of the FET 1 may be significantly reduced.

Here, a timing when the control unit CNT4 turns on the FET 1 is determined according to only a gradient of the terminal voltage Vnh of the auxiliary winding Nh. Therefore, there may be solved a problem that the FET 1 may not be turned on at the lowest point of the LC resonance voltage due to deviations between a value of Δt set by the control unit CNT2, and a value of actual Δt, resulting from variations of the parts, which have occurred in a circuit of the above-described first exemplary embodiment.

Next, when the FET 1 is turned on (from the time t54 on ward), again, the drain current Id begins to flow through the FET 1, via the primary winding Np of the transformer T2. At this time, the negative pulse voltage is induced in the secondary winding Ns. On the other hand, the positive pulse voltage is induced in the auxiliary winding Nh. The positive pulse voltage Vnhh induced in the auxiliary winding Nh is approximately expressed by the following equation, using the Vh.

$${V}_{nhh} ≅ {V}_{h} \cdot \frac{{N}_{h}}{{N}_{p}} \qquad ( 50 )$$

The Vnhh is rectified and smoothed by the diode D4 and the capacitor C5, and is supplied to the CNT4 as the power source voltage Vcc. Since that time, the CNT4 continues operation by the Vcc. At this time, when a forward voltage of the diode D4 is Vfd4, the Vcc is approximately expressed by the following equation.

$${V}_{cc} ≅ {V}_{nhh} - {V}_{fd 4} ≅ {V}_{h} \cdot \frac{{N}_{h}}{{N}_{p}} - {V}_{fd 4} \qquad ( 51 )$$

Since that time, the above-described operation from t50 to t54 is repeated.

Next, FIG. 9B illustrates operational waveforms of the pseudo-resonance converter, in the power-save mode. In the power-save mode, the output voltage drops from the Vout-h to the Vout-l, the Vcl drops as approximately expressed by the following equation.

$${V}_{cl} ≅ ( {V}_{out - l} + {V}_{fd 3} ) \cdot \frac{{N}_{p}}{{N}_{a}} \qquad ( 52 )$$

Furthermore, during turn-off of the FET 1 (duration from t42 to t43), the negative pulse voltage Vnhl induced in the auxiliary winding Nh drops as approximately expressed by the following equation.

$${V}_{nhl} ≅ ( {V}_{out - l} + {V}_{fd 3} ) \cdot \frac{{N}_{h}}{{N}_{s}} \qquad ( 53 )$$

Thereafter, as described above, the control unit CNT4 turns on the FET 1, at the timing (t64) when a gradient of the terminal voltage Vnh becomes zero from positive. During turn-on of the FET 1, the positive pulse voltage Vnhh induced in the auxiliary winding Nh is approximately expressed by the following equation, using the Vh.

$${V}_{nhh} ≅ {V}_{h} \cdot \frac{{N}_{h}}{{N}_{p}} \qquad ( 54 )$$

Therefore, the power source voltage Vcc of the control unit CNT4 is approximately expressed by the following equation.

$${V}_{cc} ≅ {V}_{nhh} - {V}_{fd 4} ≅ {V}_{h} \cdot \frac{{N}_{h}}{{N}_{p}} - {V}_{fd 4} \qquad ( 55 )$$

Here, as may be seen from the equation (55), the Vcc is not dependent on a value of the Vout-l. Hence, in the power-save mode, even when the output voltage is lowered, the power source voltage Vcc of the control unit CNT4 will never drop. Therefore, it becomes possible to sufficiently lower the output voltage in the power-save mode, and it becomes possible to further reduce power consumption in the power-save mode.

In the embodiments, the auxiliary winding Nh is configured to have the same winding direction, with respect to the primary winding Np. Accordingly, at timings (t54, t64) when the FET 1 is turned on, the terminal voltage Vnh of the auxiliary winding Nh is positive voltage. Therefore, it is also the effect of the present exemplary embodiment that it is easy to configure a detection circuit to detect the terminal voltage Vnh.

An application example of the switching power source will be described. The switching power source apparatus of the pseudo-resonance type described in the above-described first exemplary embodiment, and the second exemplary embodiment may be applied as a low-voltage power source in an image forming apparatus such as, for example, a laser beam printer, a copying machine, and a facsimile. The application example will be described below. The switching power source is applied as a power source for electric power supply to a controller as a control unit in the image forming apparatus, and for electric power supply to a motor as a driving unit of a conveyance roller for conveying sheets.

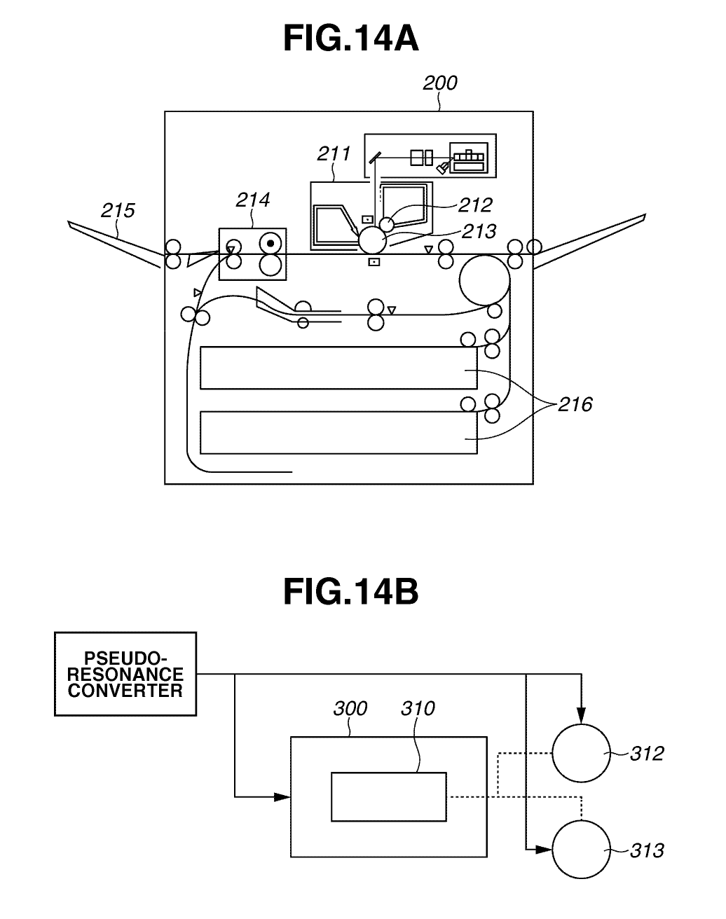

FIG. 14A illustrates a schematic configuration of a laser beam printer being an example of the image forming apparatus. A laser beam printer 200 includes, as an image forming unit 210, a photosensitive drum 211 as an image bearing member on which a latent image is formed, and a development unit 212 that develops with toner a latent image formed on the photosensitive drum. Then, a toner image developed by the photosensitive drum 211 is transferred onto a sheet (not illustrated) as a recording medium supplied from a cassette 216, and the toner image transferred on the sheet is fixed by a fixing device 214 and discharged to a tray 215.

Further, FIG. 14B illustrates a power supply line from the power source to the controller as the control unit and the motor as the driving unit of the image forming apparatus. The above-described pseudo-resonance power source may be applied as a low-voltage power source that supplies electric power to the controller 300 having a CPU 310 which controls such an image forming operation, and supplies electric power to a motor 312 and a motor 313 as the driving unit for image formation. Electric power of 3.3V is supplied to the controller 300, and electric power of 24V is supplied to the motor.

For example, the motor 312 drives the conveyance roller which conveys sheets, and the motor 313 drives the fixing device 214. The image forming apparatus such as the laser beam printer may switch between a active state in which image formation is being executed, and a inactive state in which image formation is not being executed, and electric power supply to the motors and the like is turned off for reducing power consumption.

For example, in a case where the state is switched to the inactive state, when the above-described switching power source apparatus of pseudo-resonance type is applied, power consumption in the inactive state may be further reduced. The pseudo-resonance power source explained in the above-described first exemplary embodiment, and second exemplary embodiment may be applied to a low-voltage power source for not only an image forming apparatus illustrated herein, but also other electronic devices.

While the embodiments have been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-011153 filed Jan. 21, 2011, which is hereby incorporated by reference herein in its entirety.

What is claimed is:

1. A switching power source comprising:
a transformer including a primary winding, a secondary winding having a reverse winding direction relative to that of the primary winding, and an auxiliary winding having same winding direction relative to that of the primary winding;
a switching unit configured to perform switching of an electric current input into the primary winding of the transformer; and
a control unit configured to operate by being supplied with voltage from the auxiliary winding,
wherein the control unit is configured to control a drive timing of the switching unit by using voltage supplied from the auxiliary winding, to control voltage generated in the secondary winding.

2. The switching power source according to claim 1 wherein the control unit is configured to detect a timing when a voltage supplied from the auxiliary winding becomes zero from negative voltage, and control a drive timing of the switching unit according to the detected timing.

3. The switching power source according to claim 1 wherein the control unit, when an output from a secondary winding of the transformer is switched to a low voltage, is configured to determine a timing when to turn on the switching unit according to voltage induced in the auxiliary winding.

4. The switching power source according to claim 1 wherein the control unit is configured to detect a timing when a voltage induced in the auxiliary winding has a positive gradient, and the voltage becomes a predetermined value, and determine a timing when to turn on the switching unit based on the detected result.

5. The switching power source according to claim 1 wherein the control unit is configured to detect a timing when a voltage induced in the auxiliary winding is a positive voltage, and a gradient of the positive voltage becomes zero, and determine a timing when to turn on the switching unit based on the detected result.

6. An image forming apparatus comprising:
an image forming unit;
a control unit configured to control operation of the image forming unit; and
a switching power source configured to supply electric power to the control unit, wherein the switching power source comprises:
a transformer including a primary winding, a secondary winding having reverse winding direction relative to that of the primary winding, and an auxiliary winding having same winding direction as that of the primary winding;
a switching unit configured to perform switching of an electric current input into the primary winding of the transformer; and
a control unit configured to operate by being supplied with a voltage from the auxiliary winding,
wherein the control unit is configured to control a drive timing of the switching unit by using voltage supplied from the auxiliary winding, to control a voltage generated in the secondary winding.

7. The image forming apparatus according to claim 6, wherein the control unit is configured to detect a timing when a voltage supplied from the auxiliary winding becomes zero from negative voltage, and control a drive timing of the switching unit in response to the detected timing.

8. The image forming apparatus according to claim 6, wherein the control unit, when an output from the secondary winding of the transformer is switched to a low voltage, is configured to determine a timing when to turn on the switching unit according to voltage induced in the auxiliary winding.

9. The image forming apparatus according to claim 6, wherein the control unit is configured to detect a timing when voltage induced in the auxiliary winding has a positive gradient, and the voltage becomes a predetermined value, and determine a timing when to turn on the switching unit based on the detected result.

10. The image forming apparatus according to claim 6, wherein the control unit is configured to detect a timing when voltage induced in the auxiliary winding is positive voltage, and a gradient of the positive voltage becomes zero, and determine a timing when to turn on the switching unit based on the detected result.

11. The image forming apparatus according to claim 6, wherein the image forming apparatus is configured to be capable of switching between an active state in which operation is being executed and an inactive state in which operation is being suspended, and
wherein, the control unit, when a state is switched to the inactive state, is configured to determine a timing when to turn on the switching unit according to voltage induced in the auxiliary winding.
